(19) United States
(12) Patent Application Publication
(10) Pub. No.: US 2025/0138339 A1
(43) Pub. Date: May 1, 2025

(54) GLASSES

(71) Applicant: Martin BRÄNDLE, Merching (DE)

(72) Inventor: Martin BRÄNDLE, Merching (DE)

(21) Appl. No.: 18/926,662

(22) Filed: Oct. 25, 2024

(30) Foreign Application Priority Data
Oct. 27, 2023 (DE) 102023210689.2

(51) Int. Cl. G02C 5/22

(52) U.S. Cl. CPC G02C 5/2281; G02C 2200/06

(57) ABSTRACT

A pair of eyeglasses is provided with an eyeglass frame, from which a left and a right eyeglass lens of the eyeglasses is held, and with two eyeglass temples connected to the eyeglass frame, wherein the left lens is arranged between an upper frame element and a lower left frame element of the eyeglass frame and the right lens is arranged between the upper eyeglass frame section and a lower right frame element of the eyeglass frame. In a left temple fastening region, the upper frame element and the lower left frame element extend along a common left extension direction and can are releasably fastened to one another by means of a left screw connection, which extends along a left connecting direction. In a right frame fastening region, the upper frame element and the lower right frame element extend along a common right extension direction and can be releasably fastened or are releasably fastened to one another by means of a right screw connection, which extends along a right connecting direction. The left connecting direction and the left extension direction form a left acute angle (α-l) of at least 8° in a top view onto the eyeglasses from the top. Alternatively or additionally, the right connecting direction and the right extension direction form a (right) acute angle (α-r) of at least 8°.

### CROSS-REFERENCE TO RELATED APPLICATIONS

This application claims priority from German Patent Application No. 10 2023 210 689.2, filed Oct. 27, 2023, the entirety of which is hereby incorporated by reference herein. The present invention relates to eyeglasses.

Conventional eyeglasses generally have an eyeglass frame, into which a left and a right eyeglass lens can be inserted as part of a so-called glazing of the eyeglasses—typically by an optician—as well as a left and a right eyeglass temple, which are each pivotably and releasably connected to the eyeglass frame. In the case of conventional eyeglasses, the eyeglass frame is often designed so that an upper section of the eyeglass frame is screwed to a lower left section after the insertion of the left eyeglass lens into the frame, in order to fix the left eyeglass lens in the frame in this way. The upper section of the eyeglass frame is accordingly screwed to a lower right section after the insertion of the right eyeglass lens into the frame, in order to fix the right eyeglass lens in the frame.

In the case of conventional eyeglasses, it often proves to be problematic that when working with a screwing tool, there is the risk of damage to the eyeglass frame in the region of said screw connection, but also in the region of the eyeglass temple. A removal of the eyeglass temple from the eyeglass frame can also be required for screwing together said sections of the eyeglass frame, in order to provide the required access to the screw connection to the worker with the screwing tool. However, the glazing thus turns out to be relatively complex. When releasing the eyeglass temple from the eyeglass frame, there is additionally also the risk that eyeglass frame and eyeglass temple can be damaged, in particular scratched.

It is thus an object of the present invention to provide improved eyeglasses, in the case of which the above-mentioned disadvantage is largely, preferably even completely, eliminated.

This object is solved by means of the subject matter of the independent patent claims. Preferred embodiments are subject matter of the dependent patent claims.

It is thus the basic idea of the invention to form a screw connection, which is provided on the eyeglass frame at the transition region to the eyeglass temple, for fastening two frame elements of the eyeglass frame so that the access to the screw connection with a screwing tool is simplified. It is provided for this purpose to arrange the screw connection at an acute angle of at least 8° relative to an extension of the eyeglass temple, so that working with a screwing tool—typically a screwdriver—for forming or releasing the screw connection at an angle of 8° or more also takes place relative to the eyeglass temple. The risk of damage to the eyeglass temple, but also to the eyeglass frame by means of the screwing tool is significantly reduced thereby. It is also no longer required to remove the eyeglass temple from the eyeglass frame for screwing purposes. The glazing of the eyeglasses is simplified significantly thereby. Unwanted damage to the eyeglasses by scratches or the like, as they can occur in the course of the disassembly of the eyeglass temple from the eyeglass frame, is also counteracted.

To realize the above-described idea of the invention, eyeglasses according to the invention comprise an eyeglass frame, in which a left and a right eyeglass lens of the eyeglasses is held. The eyeglasses further comprise two eyeglass temples connected to the eyeglass frame. The left eyeglass lens is arranged between an upper frame element and a lower left frame element of the eyeglass frame. The upper frame element and the lower left frame element of the eyeglass frame can frame the left eyeglass lens. The right eyeglass lens is arranged between the upper eyeglass frame section and a lower right frame element of the eyeglass frame. The upper frame element and the lower right frame element of the eyeglass frame can frame the right eyeglass lens. In a central region between the two eyeglass lenses, the upper eyeglass frame section is firmly connected to the lower left as well as to the lower right frame element. In the central region, the upper frame section as well as the lower left and the lower right frame section can be in particular be molded integrally on one another, thus formed in one piece and from the same material. In a common left temple fastening region, the upper frame element and the lower left frame element extend along a common left extension direction and are additionally releasably fastened to one another by means of a left screw connection, which extends along a left connecting direction. In a common right frame fastening region, the upper frame element and the lower right frame element extend along a common right extension direction and are releasably fastened to one another by means of a right screw connection, which extends along a right connecting direction.

According to the invention, the left connecting direction and the left extension direction are arranged at a (left) acute angle of at least 8° to one another in a top view onto the eyeglasses from the top. This provides for a screw connection of the upper frame element to the lower left frame element, without the left eyeglass temple having to be released from the eyeglass frame for this purpose. Alternatively or additionally, the right connecting direction and the right extension direction are arranged at a (right) acute angle of at least 8° to one another in a top view onto the eyeglasses. This provides for a screw connection of the upper frame element to the lower right frame element, without the right eyeglass temple having to be released from the eyeglass frame for this purpose.

Particularly preferably, the left acute angle is at least 15°, preferably at least 25°. Alternatively or additionally, the right acute angle can particularly preferably be at least 15°, preferably at least 25°. Such a geometry ensures that the respective eyeglass temple does not affect the accessibility of the assigned screw connection with a screwing tool, in particular with a screwdriver, or only to an insignificant extent.

In the case of a preferred embodiment, the left screw connection is arranged on a side, which faces the right screw connection, of the upper frame element and of the lower left frame element. Alternatively or additionally, the right screw connection is arranged on a side, which faces the left screw connection, of the upper frame element and of the lower right frame element in the case of this embodiment. Both variations improve the accessibility of the respective screw connection.

In the case of another preferred embodiment, the upper frame element can have a U-shaped geometry with a first and a second leg in the left or/and right temple fastening region. In the case of this embodiment, an extension of the first leg along the left or right extension direction, respectively, is larger than an extension of the second leg. The lower left or right frame element, respectively, thereby forms an extension of the second leg along the respective left or right extension direction, respectively. In the case of this embodiment, the second leg of the upper frame element is releasably connected to the lower left or right frame element, respectively, by means of the left or right screw connection, respectively.

According to an advantageous further development, the left screw connection is arranged in a two-piece left screw block of the eyeglasses. A first screw block part of the left screw block is thereby firmly connected to the upper frame element, and a second screw block part of the left screw block is firmly connected to the lower left frame element. The first screw block part can preferably be molded integrally on the upper frame element and the second screw block part can be molded integrally on the lower left frame element. In other words, the first screw block part and the upper frame element are formed in one piece and from the same material. The second screw block part and the lower left frame element are accordingly formed in one piece and from the same material.

Alternatively or additionally, the right screw connection is arranged in a two-piece right screw block of the eyeglasses in the case of this further development. A first screw block part of the right screw block is firmly connected to the upper frame element, and a second screw block part of the right screw block is firmly connected to the lower right frame element. The first screw block part can preferably be molded integrally on the upper frame element and the second screw block part can be molded integrally on the lower right frame element. In other words, the first screw block part and the upper frame element are formed in one piece and from the same material. The second screw block part and the lower right frame element are accordingly formed in one piece and from the same material. This further development is constructed particularly simply, which is associated with an improved design of the eyeglasses and with a particularly simple and thus comparatively cost-efficient manufacture.

According to a further advantageous further development, the two screw block parts of the left or/and right screw block are arranged consecutively and so as to rest against one another along the left or right extension direction, respectively. In the case of this further development, a screw receptacle with internal thread, which extends along the left or right extension direction, respectively, is in each case formed in both screw block parts of the left or right screw block, respectively, which merge along the extension direction, so that a threaded screw with external thread can be screwed or is screwed into the two consecutive internal threads for fixing the two screw block parts to one another. This further development is constructed technically particularly simply and additionally requires only little installation space in an advantageous manner.

Particularly preferably, the left or/and right screw block is formed so that the threaded screw can be screwed in or is screwed in on a side of the screw block, which faces away from the eyeglass lenses. The accessibility of the screw block for a worker working with a screwing tool, in particular a screwdriver, is improved thereby.

Particularly preferably, at least one of the two screw receptacles can be formed as through opening. The two screw receptacles can be produced particularly easily and thus cost-efficiently in this way.

Particularly preferably, the two screw receptacles of the left or/and right screw block are aligned with one another along the respective connecting direction. This provides for a simple screw-in of a threaded screw into the screw receptacle by a worker.

Particularly expediently, the respective acute angle is arranged in a plane, through which the respective eyeglass temple runs in response to the adjusting between the wearing position and the stowing position. Such a geometry promotes the access to the screw connection, in particular by means of a screwing tool, such as, for example, of a screwdriver, by a worker.

In the case of a further preferred embodiment, the left eyeglass temple be pivotably connected to the left temple fastening region. Alternatively or additionally, the right eyeglass temple can be pivotably connected to the right temple fastening region in the case of this further development.

According to an advantageous further development, the two eyeglass temples are each be pivotable between a wearing position and a stowing position. In the case of this further development, the left eyeglass temple, when in the wearing position, extends along the left extension direction and, alternatively or additionally, the right eyeglass temple, when in the wearing position, extends along the right extension direction.

In the case of a further preferred embodiment of the eyeglasses according to the invention, the eyeglass frame has a temple fastening section, which extends at an angle, preferably essentially at a right angle, to the frame longitudinal direction, for connecting to the at least one eyeglass temple. The temple fastening section can be bent over with respect to a main section of the eyeglass frame, in which the eyeglass lenses of the eyeglasses are also arranged. The temple fastening section is typically arranged at an angle of approximately 90° with respect to the main section. However, larger values for the angle of up to 100°, up to 110°, or even up to 120°, are also conceivable in variations.

In the case of another preferred embodiment, two hinges are in each case provided for each of the two eyeglass temples, wherein the two hinges each are formed so as to be pivotable about a common axis of rotation, which extends along a vertical direction.

Further important features and advantages of the invention follow from the subclaims, from the drawings and from the corresponding figure description on the basis of the drawings.

It goes without saying that the above-mentioned features and the features, which will be described below, cannot only be used in the respective specified combination but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

In each case schematically:

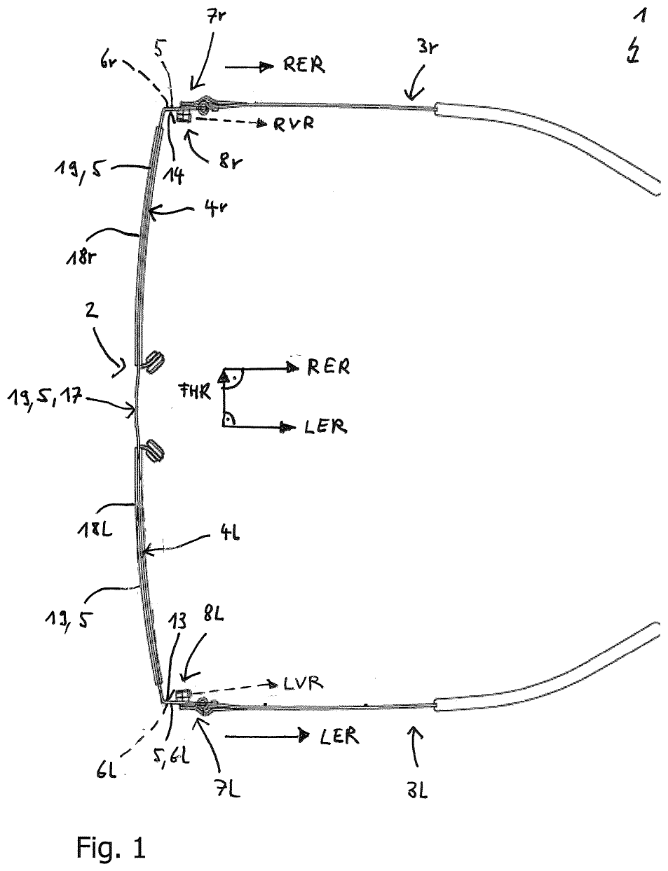

FIG. 1 shows an example of eyeglasses according to the invention, in the case of which the eyeglass temples thereof are arranged in a wearing position, in a top view from the top,

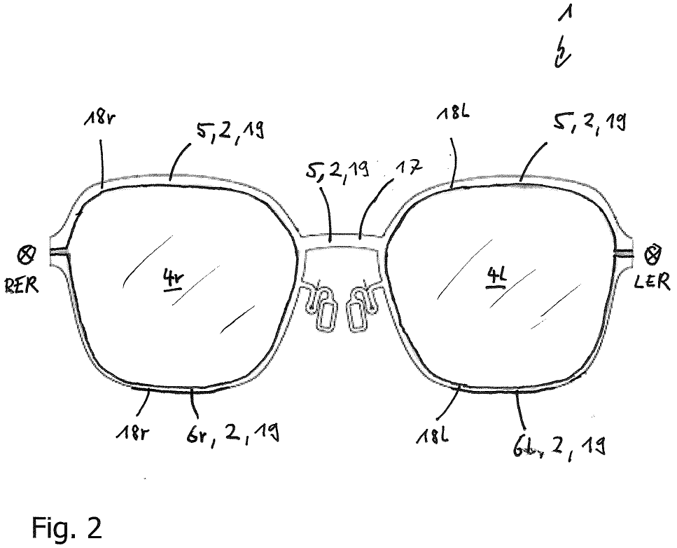

FIG. 2 shows the eyeglasses of FIG. 1 in a view from the front onto the two eyeglass lenses of the eyeglasses,

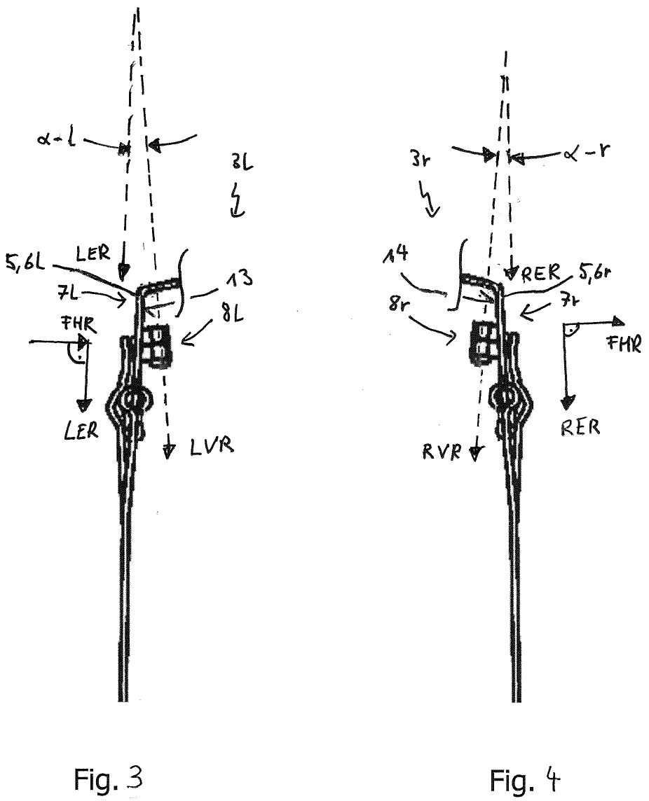

FIG. 3 shows a left eyeglass temple of the eyeglasses of FIG. 1 in a top view,

FIG. 4 shows a right eyeglass temple of the eyeglasses of FIG. 1 in a top view,

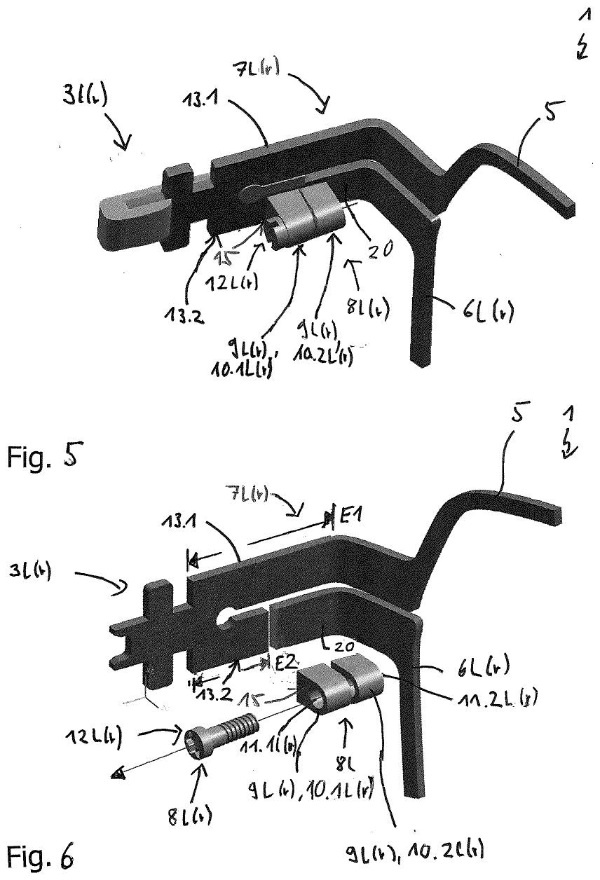

FIG. 5 shows a perspective detail illustration of the eyeglasses of FIG. 1 in the region of the left temple fastening region,

FIG. 6 shows the illustration of FIG. 5 in an exploded illustration.

FIG. 1 shows an example of eyeglasses 1 according to the invention in a top view onto the eyeglasses 1 from the top. FIG. 2 shows a front view of the eyeglasses 1 of FIG. 1. According to FIGS. 1 and 2, the eyeglasses 1 comprise an eyeglass frame 2, in which a left and a right eyeglass lens 4l, 4r of the eyeglasses 1 is received and is thus held. The left lens 4l is arranged between an upper frame element 5 and a lower left frame element 6l of the eyeglass frame 2 (see FIG. 2). The right lens 4r is arranged between the upper eyeglass frame section 5 and a lower right frame element 6r of the eyeglass frame 2. In a central region 17 between the two eyeglass lenses 4l, 4r, the upper eyeglass frame section 5 is firmly connected to the lower left as well as to the lower right frame element 6l, 6r.

According to FIG. 1, the eyeglasses 1 comprise two eyeglass temples 3l, 3r (not shown in FIG. 2), which are each pivotably and also releasably connected to the eyeglass frame 2. FIG. 3 shows a left temple 3l of the eyeglasses 1 of FIG. 1 in an enlarged partial illustration and in a top view from the top, FIG. 4 shows a right temple 3r of the eyeglasses 1 of FIG. 1 in an enlarged partial illustration and in a top view from the top. The two eyeglass temples 3, 3l, 3r can thereby each be pivoted between a wearing position and a stowing position. FIG. 1 shows the two eyeglass temples 3l, 3r in the wearing position.

In the top view, the right eyeglass temple 3r, when in the wearing position, extends along the right extension direction RER.

According to FIGS. 1 to 4, the upper frame element 5 and the lower left frame element 6l extend along a common left extension direction LER in a common left temple fastening region 7l in a top view onto the eyeglasses 1.

In the top view, the left eyeglass temple 3l, when in the wearing position, also extends along the left extension direction LER.

The upper frame element 5 and the lower left frame element 6l—in addition to the above-mentioned firm connection in the central region 17 of the upper frame section 5—are also releasably fastened to one another in the left temple fastening region 7l by means of a left screw connection 8l, which extends along a left connecting direction LVR.

This provides for the assembly of the left eyeglass lens 4l on the eyeglass frame 2. For this purpose, the left eyeglass lens 4l, when the left screw connection 8l is released, is arranged between the upper frame element 5 and the lower left frame element 6l. The upper frame element 5 and the lower left frame element 6l are then fastened to one another by means of the left screw connection 8l in the left temple fastening region 7l and are thus connected to one another. It is not required to release the left eyeglass temple 3l from the eyeglass temple 2 for this purpose. The left eyeglass lens 4l is fixed in this way in a left rim 18l, which is formed by the upper frame element 5 and by the lower left frame element 6l (see FIG. 2).

In a top view onto the eyeglasses 1, the upper frame element 5 and the lower right frame element 6r extend in a common right temple fastening region 7r along a common right extension direction RER. In the top view, the right eyeglass temple 3r, when in the wearing position, also extends along the right extension direction RER. The upper frame element 5 and the lower right frame element 6r are—in addition to the above-mentioned firm connection in the central region 17 of the upper frame section 5—are releasably fastened to one another in the right temple fastening region 7r by means of a right screw connection 8r, which extends along a right connecting direction LVR. This provides for the assembly of the right eyeglass lens 4r to the eyeglass frame 2. For this purpose, the right eyeglass lens 4r, when the right screw connection 8r is released, is arranged between the upper frame element 5 and the lower right frame element 6r. The upper frame element 5 and the lower right frame element 6r are then fastened to one another by means of the right screw connection 8l in the right temple fastening region 7r and are thus connected to one another. It is not required to release the left eyeglass temple 3l from the eyeglass temple 2 for this purpose. The right eyeglass lens 4r is fixed in this way in a right rim 18r, which is formed by the upper frame element 5 and by the lower right frame element 6r (see FIG. 2).

As illustrated by FIGS. 1, 3, 4 and 5, the left screw connection 8l is arranged on a side 13, which faces the right screw connection 8r, of the upper frame element 5 and of the lower left frame element 6l. Analogously thereto, the right screw connection 8r is arranged on a side 14, which faces the left screw connection 8r, of the upper frame element 5 and of the lower right frame element 6l.

In the example, the left and the right extension direction LER, RER run essentially parallel to one another. The left and the right extension direction LER, RER extend essentially orthogonally to a frame direction FHR, along which the eyeglass frame 2 extends with a frame main section 19, in which the two eyeglass lenses 4l, 4r (see FIG. 2) follow each other. The wording “essentially” means that deviations from said parallel or orthogonal course LER, RER, FHR, respectively, of the respective directions of up to an intermediate angle of up to 3° are possible. The two temple fastening regions 7l, 7r can be bent over with respect to the frame main section 19, as shown.

As FIGS. 1, 3, 4 and 5 show, the left connecting direction LVR and the left extension direction LER are arranged at a left acute angle α-l of approx. 8° to one another in a top view onto the eyeglasses 1 from the top (see FIG. 3). The right connecting direction RVR and the right extension direction RER are likewise arranged at a right acute angle α-r of approx. 8° to one another (see FIG. 4). In variations of the example, the left angle α-l or the right angle α-r, respectively, can also be larger than 8°. In particular values for the left or right acute angle α-l, α-r, respectively, of at least 15° or even of at least 25° are conceivable. In the example, the left acute angle α-l is arranged in a plane, through which the left eyeglass temple 4l runs in response to the adjusting between the wearing position and the stowing position. The right acute angle α-r is likewise arranged in a plane, through which the right eyeglass temple 4r runs in response to the adjusting between the wearing position and the stowing position.

FIG. 5 is a perspective detail illustration of the eyeglasses 1 in the region of the left temple fastening region 7l, FIG. 6 is an exploded illustration of FIG. 5.

According to FIGS. 5 and 6, the upper frame element 5 can have a U-shaped geometry with a first and a second leg 13.1, 13.2 in the left or/and right temple fastening region 7l. An extension E1 of the first leg 13.1 along the left extension direction LER is larger than an extension E2 of the second leg 13.2. The lower left frame element 6l thereby forms an extension 20 of the second leg 13.2 along the left extension direction LER. The second leg 13.2 of the upper frame element 5 is releasably connected to the lower left frame element 6l by means of the left screw connection 8l. The left screw connection 8l is additionally arranged in a two-piece left screw block 9l of the eyeglasses 1. A first screw block part 10.1l of the left screw block 9l is thereby firmly connected to the upper frame element 5, and a second screw block part 10.2l of the left screw block 9l is firmly connected to the lower left frame element 6l. The first screw block part 10.1l can preferably be molded integrally on the upper frame element 5 and the second screw block part 10.2l can be molded integrally on the lower left frame element 6l. In other words, the first screw block part 10.1l and the upper frame element 6 are formed in one piece and from the same material. The second screw block part 10.2l and the lower left frame element 6l are accordingly formed in one piece and from the same material.

As is clearly shown by the illustration of FIGS. 5 and 6, the two screw block parts 10.1l, 10.2l of the left screw block 9l are arranged consecutively and so as to rest against one another along the left or right extension direction LER, respectively. A screw receptacle 11.1l, 11.2l with internal thread, which extends along the left extension direction LER, is in each case formed in both screw block parts 10.1l, 10.2l of the left screw block 9l, which merge along the left extension direction LER. To fix the two left screw block parts 10l.1, 10l2 to one another, a threaded screw 12l with external thread can be screwed into the two consecutive internal threads. In the example, the left screw block 9l is formed so that the threaded screw 12l can be screwed in on a side 15 of the left screw block 9l, which faces away from the eyeglass lenses 4l, 4r. The two screw receptacles 11.1l, 12.2l of the left screw block 9l are aligned with one another along the connecting direction LVR. Each of the two screw receptacles 11.1l, 11.2l can be formed as through opening.

In the example scenario, above description relating to the left screw block 9l according to FIGS. 5 and 6 apply mutatis mutandis also for the right screw block 9r, which is not shown in FIGS. 5 and 6, so that the corresponding reference numeral is supplemented with a bracketed (r) in FIGS. 5 and 6 in order to clarify this fact.

The specification can be readily understood with reference to the following Numbered Paragraphs:

Numbered Paragraph 1. Eyeglasses (1),
with an eyeglass frame (2), by which a left and a right eyeglass lens (4l, 4r) of the eyeglasses is held, and with two eyeglass temples (3, 3l, 3r) pivotably and releasably connected to the eyeglass frame (2),
wherein the left lens (4l) is arranged between an upper frame element (5) and a lower left frame element (6l) of the eyeglass frame (2) and the right lens (4r) is arranged between the upper eyeglass frame section (5) and a lower right frame element (6r) of the eyeglass frame (2),
wherein in a central region (17) between the two eyeglass lenses (4l, 4r), the upper eyeglass frame section (5) is firmly connected to the lower left as well as to the lower right frame element (6l, 6r),
wherein in a left temple fastening region (7l), the upper frame element (5) and the lower left frame element (6l) extend along a common left extension direction (LER) and can be releasably fastened or are releasably fastened to one another by means of a left screw connection (8l), which extends along a left connecting direction (LVR) in addition to the firm connection,
wherein in a right frame fastening region (7r), the upper frame element (5) and the lower right frame element (6r) extend along a common right extension direction (RER) and can be releasably fastened or are releasably fastened to one another by means of a right screw connection (8r), which extends along a right connecting direction (LVR) in addition to the firm connection,
wherein the left connecting direction (LVR) and the left extension direction (LER) form a (left) acute angle (α-l) of at least 8° from the top in a top view onto the eyeglasses (1) or/and wherein the right connecting direction (RVR) and the right extension direction (RER) form a (right) acute angle (α-r) of at least 8°.

Numbered Paragraph 2. The eyeglasses according to Numbered Paragraph 1,
characterized in that
the left acute angle (α-l) is at least 15°, preferably at least 25°; or/and that
the right acute angle (α-r) is at least 15°, preferably at least 25°.

Numbered Paragraph 3. The eyeglasses according to Numbered Paragraph 1 or 2,
characterized in that
the left screw connection (8l) is arranged on a side (13), which faces the right screw connection (8r), of the upper frame element (5) and of the lower left frame element (6l); or/and the
the right screw connection (8r) is arranged on a side (14), which faces the left screw connection (8l), of the upper frame element (5) and of the lower right frame element (8r).

Numbered Paragraph 4. The eyeglasses according to one of Numbered Paragraphs 1 to 3,

characterized in that
the upper frame element (5) has a U-shaped geometry with a first and a second leg (13.1, 13.2) in the left or/and right temple fastening region (7l, 7r),
an extension (E1) of the first leg (13.1) along the left or right extension direction (LER, RER), respectively, is larger than an extension (E2) of the second leg (13.2), respectively,
the lower left or right frame element (6l, 6r), respectively, forms an extension (20) of the second leg (13.2) along the respective extension direction (LER, RER),
the second leg (13) of the upper frame element (5) is releasably connected to the lower left or right frame element (6l, 6r), respectively, by means of the left or right screw connection (8l, 8r), respectively.

Numbered Paragraph 5. The eyeglasses according to one of the preceding Numbered Paragraphs,

characterized in that
the left screw connection (8) is arranged in a two-piece left screw block (9l) of the eyeglasses (1), wherein a first screw block part (10l.1) of the left screw block (9l) is firmly connected to the upper frame element (5) and a second screw block part (10l.2) of the left screw block (9l) is firmly connected to the lower left frame element (6l); or that
the right screw connection (8) is arranged in a two-piece right screw block (9r) of the eyeglasses (1), wherein a first screw block part (10r.1) of the right screw block (9r) is firmly connected to the upper frame element (5) and a second screw block part (101.2) of the right screw block (9r) is firmly connected to the lower right frame element (6r).

Numbered Paragraph 6. The eyeglasses according to Numbered Paragraph 5,

characterized in that
the two screw block parts (10l.1, 10l.2, 10r.1, 10r.2) of the left or/and right screw block (9l, 9r) are arranged consecutively and so as to rest against one another along the left or right extension direction (LER, RER), respectively,
a screw receptacle (11l.1, 11l.2, 11r.1, 11r.2) with internal thread, which extends along the left or right extension direction (LER, RER), respectively, is in each case formed in both screw block parts (10l.1, 10l.2, 10r.1, 10r.2) of the left or right screw block (9l, 9r), respectively, which merge along the extension direction (LER, RER), so that a threaded screw (12l, 12r) with external thread can be screwed or is screwed into the two consecutive internal threads for fixing the two screw block parts (10l.1, 10l.2, 10r.1, 10r.2) to one another.

Numbered Paragraph 7. The eyeglasses according to Numbered Paragraph 5 or 6,

characterized in that
the left or/and right screw block (9l, 9r) is formed so that the threaded screw (12l, 12r) can be screwed in or is screwed in on a side (15, 16) of the screw block (9l, 9r), which faces away from the eyeglass lenses.

Numbered Paragraph 8. The eyeglasses according to Numbered Paragraph 6 or 7,

characterized in that
at least one of the two screw receptacles (11l.1, 11l.2, 11r.1, 11r.2) is formed as through opening.

Numbered Paragraph 9. The eyeglasses according to one of Numbered Paragraphs 6 to 8,

characterized in that
the two screw receptacles (11l.1, 11l.2, 11r.1, 11r.2) are aligned with one another along the respective connecting direction (LVR, RVR).

Numbered Paragraph 10. The eyeglasses according to one of the preceding Numbered Paragraphs,

characterized in that
the respective acute angle (α-l, α-r) is arranged in a plane, through which the respective eyeglass temple (4l, 4r) runs in response to the adjusting between the wearing position and the stowing position.

Numbered Paragraph 11. The eyeglasses according to one of the preceding Numbered Paragraphs,

characterized in that
the left eyeglass temple (3l) is pivotably connected to the left temple fastening region (7l); or and/or that
the right eyeglass temple (3r) is pivotably connected to the right temple fastening region (7r).

Numbered Paragraph 12. The eyeglasses according to one of the preceding Numbered Paragraphs,

characterized in that
the two eyeglass temples (3, 3l, 3r) can each be pivoted between a wearing position and a stowing position,
the left eyeglass temple (3l), when in the wearing position, extends along the left extension direction (LER); or/and that the right eyeglass temple (3r), when in the wearing position, extends along the right extension direction (RER).

1-12. (canceled)

13. An apparatus configured to act as a pair of eyeglasses, comprising,
an eyeglass frame, by which a left and a right eyeglass lens of the pair of eyeglasses is held, and with two eyeglass temples pivotably and releasably connected to the eyeglass frame,
wherein the left lens is arranged between an upper frame element and a lower left frame element of the eyeglass frame and the right lens is arranged between the upper eyeglass frame section and a lower right frame element of the eyeglass frame,
wherein in a central region between the two eyeglass lenses, the upper eyeglass frame section is firmly connected to the lower left as well as to the lower right frame element,
wherein in a left temple fastening region, the upper frame element and the lower left frame element extend along a common left extension direction and can be releasably fastened or are releasably fastened to one another by means of a left screw connection, which extends along a left connecting direction in addition to the firm connection,
wherein in a right frame fastening region, the upper frame element and the lower right frame element extend along a common right extension direction and can be releasably fastened or are releasably fastened to one another by means of a right screw connection, which extends along a right connecting direction in addition to the firm connection, and
wherein the left connecting direction and the left extension direction form a (left) acute angle (α-l) of at least 8° from the top in a top view onto the pair of eyeglasses or/and wherein the right connecting direction and the right extension direction form a (right) acute angle (α-r) of at least 8°.

14. The apparatus configured to act as a pair of eyeglasses according to claim 13, wherein the left acute angle (α-l) is at least 15°; or the right acute angle (α-r) is at least 15°.

15. The apparatus configured to act as a pair of eyeglasses according to claim 13, wherein the left screw connection is arranged on a side, which faces the right screw connection, of the upper frame element and of the lower left frame element; or, the right screw connection is arranged on a side, which faces the left screw connection, of the upper frame element and of the lower right frame element.

16. The apparatus configured to act as a pair of eyeglasses according to claim 13, wherein the upper frame element has a U-shaped geometry with a first and a second leg in the left or/and right temple fastening region, an extension of the first leg along the left or right extension direction, respectively, is larger than an extension of the second leg, respectively, the lower left or right frame element, respectively, forms an extension of the second leg along the respective extension direction, and the second leg of the upper frame element is releasably connected to the lower left or right frame element, respectively, by the left or right screw connection, respectively.

17. The apparatus configured to act as a pair of eyeglasses according to claim 13, wherein the left screw connection is arranged in a two-piece left screw block of the pair of eyeglasses, wherein a first screw block part of the left screw block is firmly connected to the upper frame element and a second screw block part of the left screw block is firmly connected to the lower left frame element; or
the right screw connection is arranged in a two-piece right screw block of the pair of eyeglasses, wherein a first screw block part of the right screw block is firmly connected to the upper frame element and a second screw block part of the right screw block is firmly connected to the lower right frame element.

18. The apparatus configured to act as a pair of eyeglasses according to claim 17, wherein the two screw block parts of the left or right screw block are arranged consecutively and so as to rest against one another along the left or right extension direction, respectively, and
a screw receptacle with internal thread, which extends along the left or right extension direction, respectively, is in each case formed in both screw block parts of the left or right screw block, respectively, which merge along the extension direction, so that a threaded screw with external thread can be screwed or is screwed into the two consecutive internal threads for fixing the two screw block parts to one another.

19. The apparatus configured to act as a pair of eyeglasses according to claim 17, wherein the left or/and right screw block is formed so that the threaded screw can be screwed in or is screwed in on a side of the screw block, which faces away from the eyeglass lenses.

20. The apparatus configured to act as a pair of eyeglasses according to claim 18, wherein at least one of the two screw receptacles is formed as through opening.

21. The apparatus configured to act as a pair of eyeglasses according to one of claim 18, wherein the two screw receptacles are aligned with one another along the respective connecting direction.

22. The apparatus configured to act as a pair of eyeglasses according to claim 13, wherein the respective acute angle is arranged in a plane, through which the respective eyeglass temple runs in response to the adjusting between the wearing position and the stowing position.

23. The apparatus configured to act as a pair of eyeglasses according to claim 13, wherein the left eyeglass temple is pivotably connected to the left temple fastening region; or the right eyeglass temple is pivotably connected to the right temple fastening region.

24. The apparatus configured to act as a pair of eyeglasses according to claim 13, wherein the two eyeglass temples can each be pivoted between a wearing position and a stowing position, and
the left eyeglass temple, when in the wearing position, extends along the left extension direction; or/and that the right eyeglass temple, when in the wearing position, extends along the right extension direction.

25. The apparatus configured to act as a pair of eyeglasses according to claim 14, wherein the left acute angle (α-l) is at least 25°; or the right acute angle (α-r) is at least 25°.

26. The apparatus configured to act as a pair of eyeglasses according to claim 25, wherein the left acute angle (α-l) is at least 25°; and the right acute angle (α-r) is at least 25°.

27. The apparatus configured to act as a pair of eyeglasses according to claim 14, wherein the left acute angle (α-l) is at least 15°; and the right acute angle (α-r) is at least 15°.

28. The apparatus configured to act as a pair of eyeglasses according to claim 15, wherein the left screw connection is arranged on a side, which faces the right screw connection, of the upper frame element and of the lower left frame element; and
the right screw connection is arranged on a side, which faces the left screw connection, of the upper frame element and of the lower right frame element.

29. The apparatus configured to act as a pair of eyeglasses according to claim 18, wherein the two screw block parts of the left and right screw block are arranged consecutively and so as to rest against one another along the left or right extension direction, respectively, and
a screw receptacle with internal thread, which extends along the left or right extension direction, respectively, is in each case formed in both screw block parts of the left or right screw block, respectively, which merge along the extension direction, so that a threaded screw with external thread can be screwed or is screwed into the two consecutive internal threads for fixing the two screw block parts to one another.

30. The apparatus configured to act as a pair of eyeglasses according to claim 23, wherein the left eyeglass temple is pivotably connected to the left temple fastening region; or and the right eyeglass temple is pivotably connected to the right temple fastening region.
